(19) United States
(12) Patent Application Publication
(10) Pub. No.: US 2009/0063168 A1
(43) Pub. Date: Mar. 5, 2009

(54) CONDUCTING MARKETING ACTIVITY IN RELATION TO A VIRTUAL WORLD BASED ON MONITORED VIRTUAL WORLD ACTIVITY

(76) Inventors: Peter G. Finn, Brampton (CA); Rick A. Hamilton, II, Charlottesville, VA (US); Ian Hughes, Southampton (GB); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 11/846,724

(22) Filed: Aug. 29, 2007

(51) Int. Cl. G06Q 30/00

(52) U.S. Cl. 705/1

(57) ABSTRACT

A method, system and computer program product for conducting a marketing activity are disclosed. An activity of an avatar in a virtual world is monitored and a key word is extracted from the monitored activity. A marketing activity is determined based on the extracted key word.

### FILED OF THE INVENTION

The present disclosure relates in general to a virtual world, and more particularly to conducting marketing activities in relation to a virtual world.

### BACKGROUND OF THE INVENTION

Virtual worlds represent the latest technological forefront and present a tremendous new outlet for both structured and unstructured virtual collaboration, virtual gaming and exploration, and real-life simulation in virtual world spaces. A virtual world is a computer-based simulated environment for a user to participate via a virtual representation, referred to as an “avatar”. In a virtual world, e.g., SECOND LIFE® owned by Linden Lab, a virtual world user is provided with tools to view, navigate, and modify the virtual world space and participate in its virtual activities. These virtual activities, along with various yet to be created new dimensions, provide a wide open arena for creative and new advertising methods and mechanisms.

A virtual universe is a combination of multiple virtual worlds that are interlinked. The interlinked virtual worlds are not currently in place but have been discussed in open forums and are well understood in terms of enabling arts.

### SUMMARY OF THE INVENTION

A first aspect of the invention is directed to a method for conducting a marketing activity, the method comprising: monitoring an activity of an avatar in a virtual environment; and conducting a marketing activity based on the monitored activity of the avatar.

A second aspect of the invention is directed to a system for conducting a marketing activity, the system comprising: means for monitoring an activity of an avatar in a virtual environment; and means for conducting a marketing activity based on the monitored activity of the avatar.

A third aspect of the invention is directed to a computer program product embodied in a computer readable medium comprising: computer usable program code which, when executed by a computer system, enables the computer system to: monitor an activity of an avatar in a virtual environment; and conduct a marketing activity based on the monitored activity of the avatar.

A fourth aspect of the invention is directed to a method for generating a system for conducting a marketing activity, comprising: providing a computer infrastructure being operable to: monitor an activity of an avatar in a virtual environment; and conduct a marketing activity based on the monitored activity of the avatar.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

The embodiments of this disclosure will be described in detail, with reference to the following figures, wherein like designations denote like elements, and wherein:

FIG. 1 shows a block diagram of a system according to an embodiment of the invention.

FIG. 2 shows a block diagram of an illustrative computer environment according to an embodiment of the invention.

FIG. 3 shows an embodiment of the operation of a marketing analysis system.

It is noted that the drawings of the disclosure are not to scale. The drawings are intended to depict only typical aspects of the disclosure, and therefore should not be considered as limiting the scope of the invention. In the drawings, like numbering represents like elements among the drawings.

### DETAILED DESCRIPTION OF THE DISCLOSURE

The following detailed description of embodiments refers to the accompanying drawings, which illustrate specific embodiments of the disclosure. Other embodiments having different structures and operations do not depart from the scope of the present invention.

### 1. SYSTEM OVERVIEW

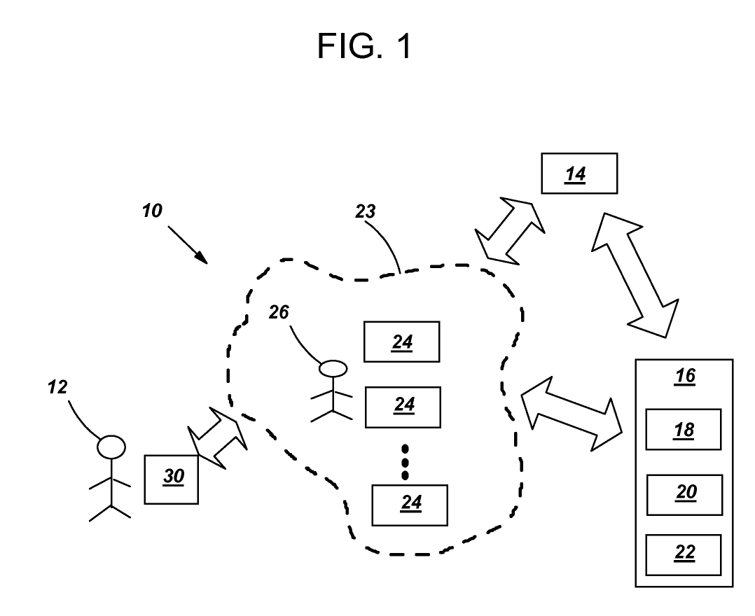

FIG. 1 shows a block diagram of a system 10 according to an embodiment. System 10 includes a virtual world user 12, a virtual world server 14 and a marketing center 16. Marketing center 16 includes a conduct monitoring unit 18, an analysis unit 20 and a relationship database 22. Virtual world server 14 supports a virtual universe 23 including multiple virtual environments 24 where virtual world user 12 may conduct activities via a virtual world representation usually referred to as an avatar 26. In operation, user 12 attends virtual universe 23 through a virtual world client 30, e.g., a personal computer, coupled to virtual world server 14. Conduct monitoring unit 18 monitors the activities of avatar 26 in virtual universe 23 or specifically in a virtual environment 24, and/or activities and other information with respect to virtual world user 12 in the real physical world. Based on the monitoring results, analysis unit 20 determines a suitable marketing activity to be conducted in relation to virtual universe 23. For example, analysis unit 20 may select an advertisement to be displayed within the specific virtual environment 24 where avatar 26 is located. It should be appreciated that the marketing activity may be conducted in any manner provided that the relevant information can be communicated to virtual world user 12. For example, analysis unit 20 may communicate an advertisement message to virtual world user 12 through, e.g., an email, if this manner is accepted by the virtual world user 12. In analyzing the monitoring results, analysis unit 20 may need to retrieve information from relationship database 22.

As is appreciated, any activity performed by avatar 26 in a virtual environment 24 may be monitored. According to an embodiment, a communication to/from an avatar 26 is a preferred activity that analysis unit 20 uses to determine a marketing activity. In virtual environment 24, avatars 26 may communicate with one other or with virtual environment 24 via various methods, for example,

(1) avatars 26 that reside in the same virtual environment 24 may chat with one another, e.g., a user 12 of an avatar 26 may input words through an input device and the words are displayed on virtual world client 30 of a user 12 of another avatar 26 that is in the same virtual environment 24;

(2) virtual world Instant message is another form of communication, which does not require that avatars 26 are in the same proximity of one another in a virtual environment 24 provided that at least one of the avatars 26 involved in the communication is in virtual universe 23;

(3) Virtual World Voice over Internet Protocol (VoIP) may be used, where voice of a user 12 is digitized and then transmitted over Transmission Control Protocol (TCP) in to a virtual world client 30 of another user 12, as long as one of the users 12 involved in the conversation resides within virtual universe 23;

(4) a gesture displayed by one avatar 26 for the benefit of another avatar 26 may also be used to communicate a message, which requires that one avatar 26 must be able to view the gesture of the other avatar 26;

5) video that is displayed to or requested by avatar 26 inside virtual universe 23;

(6) music that is displayed to or requested by avatar 26 inside virtual universe 23;

(7) an object that is requested, displayed, brandished, or put away for the purpose of interaction in virtual universe 23 or for the purpose of transmitting information to another avatar 26; and

(8) any form of data that is requested by or provided to an avatar 26 in virtual universe 23.

It should be appreciated that the forms/methods of communication listed above are for illustrative purposes and do not limit the scope of the invention.

Conduct monitoring unit 18 may also access other data available in the real physical world regarding a user 12. For example, if a user 12 plays a game in a virtual environment 24 using a personal computer, conduct monitoring unit 18 may collect data on activities within that physical computing environment, e.g., the user 12 visiting internet sites featuring sports cars. Analysis unit 20 may use the physical environment activities of the user 12 together with the activities of the respective avatar 26 in virtual universe 23 to determine an appropriate marketing activity. As is appreciated, a prior approval may need to be obtained for monitoring activities of user 12 in a physical environment.

As is appreciated, virtual world server 14 and marketing center 16 and components thereof may be positioned at the same physical location or may be at different physical locations

The interaction of system 10 components will be described herein in detail together with a computer environment.

### 2. COMPUTER ENVIRONMENT

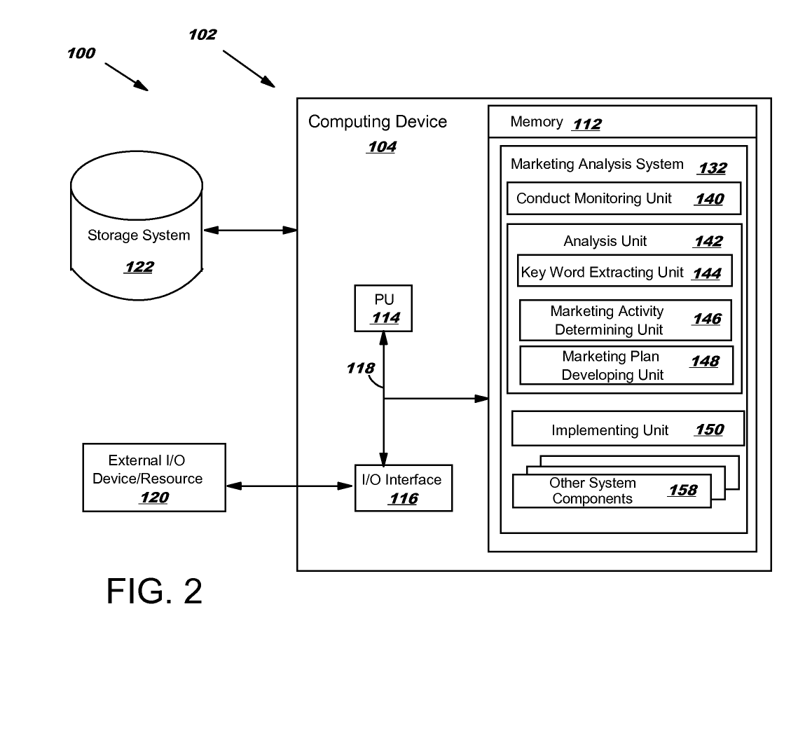

FIG. 2 shows an illustrative environment 100 for conducting a marketing activity. To this extent, environment 100 includes a computer infrastructure 102 that can perform the various processes described herein for conducting a marketing activity in relation to virtual universe 23 (FIG. 1). In particular, computer infrastructure 102 is shown including a computing device 104 that comprises a marketing analysis system 132, which enables computing device 104 to perform the process(es) described herein.

Computing device 104 is shown including a memory 112, a processing unit (PU) 114, an input/output (I/O) interface 116, and a bus 118. Further, computing device 104 is shown in communication with an external I/O device/resource 120 and a storage system 122. In general, PU 114 executes computer program code, such as marketing analysis system 132, that is stored in memory 112 and/or storage system 122. While executing computer program code, PU 114 can read and/or write data to/from memory 112, storage system 122, and/or I/O interface 116. Bus 118 provides a communications link between each of the components in computing device 104. I/O interface 116 can comprise any device that enables a user to interact with computing device 104 or any device that enables computing device 104 to communicate with one or more other computing devices. External I/O device/resource 120 can be coupled to the system either directly or through I/O interface 116.

In any event, computing device 104 can comprise any general purpose computing article of manufacture capable of executing computer program code installed thereon. However, it is understood that computing device 104 and marketing analysis system 132 are only representative of various possible equivalent computing devices that may perform the various processes of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in an embodiment, computer infrastructure 102 comprises two or more computing devices that communicate over any type of wired and/or wireless communications link, such as a network, a shared memory, or the like, to perform the various processes of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

Marketing analysis system 132 includes a conduct monitoring unit 140; an analysis unit 142 including a keyword extracting unit 144, a marketing activity determining unit 146, and a marketing plan developing unit 148; an implementing unit 150; and other system components 158. Other system components 158 may include any now known or later developed parts of marketing analysis system 132 not individually delineated herein, but understood by those skilled in the art. As should be appreciated, components of computer infrastructure 102 and marketing analysis system 132 may be located at different physical locations or at the same physical location.

According to an embodiment, computer infrastructure 102 and marketing analysis system 132 may be used to implement, inter alia, marketing center 16 of system 10 (FIG. 1). For example, conduct monitoring unit 140 and analysis unit 142 may implement conduct monitoring unit 18 and analysis unit 20, respectively, and storage system 122 may include relationship database 22 (FIG. 1).

Inputs/outputs to computer infrastructure 102, e.g., through external I/O device/resource 120 and/or I/O interface 116, may include information communicated between and among various components of system 10, as is described herein in detail. The operation of system 10 and marketing analysis system 132 are described together herein in detail.

### 3. OPERATION METHODOLOGY

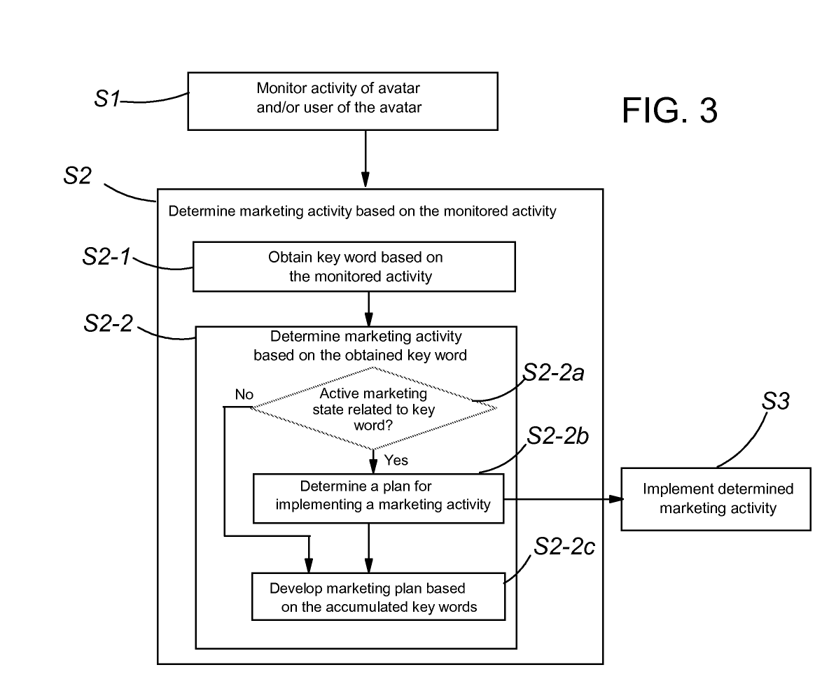

An embodiment of the operation of marketing analysis system 132 is shown in the flow diagram of FIG. 3. Referring to FIGS. 1-3 collectively, in process S1, conduct monitoring unit 140 monitors an activity of an avatar 26 in a virtual environment 24 and/or a user 12 of the avatar 26 in a physical environment. Any method may be used in the monitoring, and all are included. For example, conduct monitoring unit 140 may coordinate with virtual world server 14 in conducting the monitoring. Conduct monitoring unit 140 may instruct virtual world server 14 to submit, preferably in substantially real time, a record of the activities of an avatar 26 thereto. Conduct monitoring unit 140 may choose to monitor a certain types of activities of avatar 26/virtual world user 12 or may collect all activities. In addition, the context of the activities of avatar 26 in virtual universe 23/virtual environment 24 may also be monitored to, e.g., interpret the activities. For example, conduct monitoring unit 140 may collect data regarding the virtual locations, surroundings, and articles in the virtual environment 24 where activities of avatar 26 occur. Conduct monitoring unit 140 may also collect data regarding other avatars 26 involved in the activities of the avatar 26 of interest.

In process S2, analysis unit 142 determines a marketing activity based on the monitored activity of avatar 26 and/or virtual world user 12. Process S2 may include a plurality of sub-processes. In sub-process S2-1, key word extracting unit 144 obtains a key word based on the monitored activity. Any method of extracting a key word from the activities may be used, and all are included. For example, key word extracting unit 144 may obtain a key word from the communications of avatar 26, or may do so by interpreting the monitored activities. For example, if an avatar 26 is monitored to be waving a hand (a gesture) to a sports car salesman in a virtual environment 24, key word extracting unit 144 may interpret the activity and extract a key word of “sports car”. In determining the key word, a virtual environment 24 context of the monitored activity is also considered.

According to an embodiment, key word extracting unit 144 may obtain an initial key word directly based on the monitored activity and may further obtain at least one secondary key word based on the first key word. For example, key word extracting unit 144 may search relationship database 22 to obtain secondary key words that are similar to/related to the initial key words.

In sub-process S2-2, marketing activity determining unit 146 determines a marketing activity based on the extracted key words. A marketing activity may include any activity to market a product and/or a service. Any method to determine a marketing activity based on the key word may be used, and all are included. For example, in S2-2a, marketing activity determining unit 146 may search relationship database 22 regarding a marketing state related to the extracted key words. An “active” marketing state indicates that there is an active marketing plan related to the key word. An “inactive” state indicates that no active marketing plan is related to the key word.

For a key word with an active marketing state, in S2-2b, marketing activity determining unit 146 further determines a plan for implementing a marketing activity. The implementation plan is determined in consideration of the virtual environment 24 context of the monitored activity. For example, if the key word “sports car” with an active marketing state is extracted from a communication through a VoIP between avatars 26 in two different virtual environments 24, marketing activity determining unit 146 may determine to display advertisements for sports cars in both virtual environments 24. For another example, if the key word “singer Z” with an active marketing state is extracted through avatar 26 playing a song of singer Z, marketing activity determining unit 146 may determine to display a pop-up advertisement for a new CD of singer Z to the client 30 of the user 12 in control of the avatar 26. The determined implementation plan will be implemented by implementing unit 150 in process S3. In addition, the key word with active marketing plan will be saved and accumulated by marketing development unit 148 in S2-2c for further development of marketing activities, as will be described herein.

For a key word with an inactive marketing state, the processing goes directly to S2-2c, where marketing development unit 148 saves the key word and update a counter for accumulating key words. The accumulated key word counter will be used in developing new marketing plans. For example, if an identified key word does not have an active marketing plan associated with it, i.e., no agreement with clients regarding making advertisements in the virtual world, marketing development unit 148 may use the accumulated key words to contact potential clients regarding on-line/virtual world advertisement. If an identified key word already has an active marketing plan with it, the accumulated key words may be used to indicate the volume of advertisement actively displayed such that marketing development unit 148 may adjust the marketing plan accordingly.

### 4. CONCLUSION

While shown and described herein as a method and system for conducting a marketing activity, it is understood that the disclosure further provides various alternative embodiments. For example, in an embodiment, the invention provides a program product stored on a computer-readable medium, which when executed, enables a computer infrastructure to conduct a marketing activity. To this extent, the computer-readable medium includes program code, such as marketing analysis system 132 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 2) and/or storage system 122 (FIG. 2), and/or as a data signal traveling over a network (e.g., during a wired/wireless electronic distribution of the program product).

It should be appreciated that the teachings of the present invention could be offered as a business method on a subscription or fee basis. For example, a marketing center 16 (FIG. 1), and a computing device 104 comprising marketing analysis system 132 (FIG. 2) could be created, maintained and/or deployed by a service provider that offers the functions described herein for customers. That is, a service provider could offer to provide a service to conduct a marketing activity as described above.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for conducting a marketing activity, the method comprising:
monitoring an activity of an avatar in a virtual environment; and
conducting a marketing activity based on the monitored activity of the avatar.

2. The method of claim 1, wherein the conducting includes obtaining a key word based on the monitored activity and determining a marketing activity based on the key word.

3. The method of claim 2, wherein the key word obtaining includes obtaining a first key word directly based on the monitored activity and obtaining a second key word based on the first key word.

4. The method of claim 1, wherein the activity is a communication conducted by the avatar.

5. The method of claim 1, further comprising conducting the marketing activity based on a virtual environment context of the monitored activity.

6. The method of claim 1, further comprising collecting information regarding a user of the avatar in a physical environment and using the physical environment information together with the virtual environment activity in conducting a marketing activity.

7. The method of claim 1, further comprising developing a new marketing plan based on the monitored activity.

8. A system for conducting a marketing activity, the system comprising:
means for monitoring an activity of an avatar in a virtual environment; and
means for conducting a marketing activity based on the monitored activity of the avatar.

9. The system of claim 8, further comprising means for obtaining a key word based on the monitored activity and means for determining a marketing activity based on the key word.

10. The system of claim 9, wherein the key word obtaining means obtains a first key word directly based on the monitored activity and obtains a second key word based on the first key word.

11. The system of claim 8, wherein the activity is a communication conducted by the avatar.

12. The system of claim 8, wherein the conducting means conducts the marketing activity based on a virtual environment context of the monitored activity.

13. The system of claim 8, wherein the monitoring means further collects information regarding a user of the avatar in a physical environment and the conducting means uses the physical environment information together with the virtual environment activity in conducting a marketing activity.

14. The system of claim 8, further comprising means for developing a new marketing plan based on the monitored activity.

15. A computer program product embodied in a computer readable medium comprising:
computer usable program code which, when executed by a computer system, enables the computer system to:
monitor an activity of an avatar in a virtual environment; and
conduct a marketing activity based on the monitored activity of the avatar.

16. The program product of claim 15, wherein the program code is further configured to enable the computer system to obtain a key word based on the monitored activity and determine a marketing activity based on the key word.

17. The program product of claim 16, wherein the program code is further configured to enable the computer system to obtain a first key word directly based on the monitored activity and obtain a second key word based on the first key word.

18. The program product of claim 15, wherein the activity is a communication conducted by the avatar.

19. The program product of claim 15, wherein the program code is further configured to enable the computer system to conduct the marketing activity based on a virtual environment context of the monitored activity.

20. The program product of claim 15, wherein the program code is further configured to enable the computer system to collect information regarding a user of the avatar in a physical environment and to use the physical environment information together with the virtual environment activity in conducting a marketing activity.

21. The program product of claim 15, wherein the program code is further configured to enable the computer system to develop a new marketing plan based on the monitored activity.

22. A method for generating a system for conducting a marketing activity, comprising:
providing a computer infrastructure being operable to:
monitor an activity of an avatar in a virtual environment; and
conduct a marketing activity based on the monitored activity of the avatar.

23. The method of claim 22, wherein the computer infrastructure is further operable to obtain a key word based on the monitored activity and determine a marketing activity based on the key word.

24. The method of claim 23, wherein the computer infrastructure is operable to obtain a first key word directly based on the monitored activity and obtain a second key word based on the first key word.

25. The method of claim 22, wherein the activity is a communication conducted by the avatar.

26. The method of claim 22, wherein the computer infrastructure is operable to conduct the marketing activity based on a virtual environment context of the monitored activity.

27. The method of claim 22, wherein the computer infrastructure is operable to collect information regarding a user of the avatar in a physical environment and to use the physical environment information together with the virtual environment activity in conducting a marketing activity.

28. The method of claim 22, wherein the computer infrastructure is operable to develop a new marketing plan based on the monitored activity.

29. The method of claim 22, wherein a service provider at least one of creates, maintains, deploys and supports the computer infrastructure that performs the operations of claim 22.
